(19) United States
(12) Patent Application Publication
(10) Pub. No.: US 2005/0192453 A1
(43) Pub. Date: Sep. 1, 2005

(54) Device and method or disabling electronic devices

(76) Inventors: Wilhelm Eckl, Karlsruhe (DE); Norbert Eisenreich, Pfinztal (DE); Franz Weller, Aalen-Waldhausen (DE); Haus Ebeling, Karlsruhe (DE); Jochen Neutz, Karlsruhe (DE)

Correspondence Address: PATENTANWAELTE LICHTI + PARTNER GBR, POSTFACH 41 07 60, D-76207, KARLSRUHE, DE

(21) Appl. No.: 10/502,576

(22) PCT Filed: Jan. 29, 2003
(86) PCT No.: PCT/EP03/00876

§ 371 Date: Apr. 25, 2005

(30) Foreign Application Priority Data
Feb. 6, 2002 (DE) 102-04-685.9

(51) Int. Cl. C07F 1/00

(52) U.S. Cl. 556/1

(57) ABSTRACT

The invention relates to a device and a method for disabling electronic devices in order to reliably prevent third parties from gaining unauthorized knowledge of data in the event of loss of the storage medium. The device comprises a gas generator, with a pyrotechnic propelling charge, disposed in the area of the storage medium. At least one fuel or at least one oxidator of the propelling charge releases, when the latter is triggered, well conducting metals, especially precious or semi-precious metals which are deposited on the electronic parts of the electronic device. According to the inventive method, the igniter can be triggered manually, by sensors or remote-controlled. The invention further relates to an electronic data processing system and a telephone comprising such a device.

The invention concerns a device for disabling electronic devices and a corresponding method.

A plurality of data is currently stored on electronic storage media such as hard disks of computers or laptops, microchips of mobile databases, schedulers, mobile telephones or the like. One generally thereby tries to prevent unauthorized third parties from accessing this data. This concerns, in particular, information which is subject to data protection or requires secrecy for other reasons, e.g. for safety or military reasons. Moreover, companies are fundamentally interested in keeping internal information secret, e.g. research results, customer data etc.

In particular, in view of the continuous increase of storage capacity of electronic data carriers, the prevention of unauthorized access to the stored data is a necessity. This requirement is more important for portable devices such as laptops, schedulers or mobile telephones since they are often stolen and the software protection against access to the stored data, such as passwords or the like, is often inadequate. Moreover, in certain cases, one would like to render such electronic devices unusable.

It is the underlying purpose of the invention to disable electronic devices in a safe and reliable manner.

The inventive object is achieved with a corresponding method using a gas generator having a pyrotechnical propellant, wherein, upon triggering, at least one combustible or at least one oxidant of the propellant releases metals, in particular, precious or semi-precious metals having good conducting properties which deposit on the electronic parts of the electronic device.

The inventive design ensures that metals, in particular, metal-containing aerosols are deposited between conducting tracks of circuit boards when the gas generator is ignited, producing conductive connections which cause a short-circuit between the strip conductors thereby disabling function of the device. If the electric device contains storage media, the invention irreversibly damages same with the result that the data stored thereon is irretrievably destroyed and unauthorized access to the data is reliably prevented.

To prevent health damage and untimely triggering of the gas generator, the propellant should be thermally-mechanically insensitive, and the propellant and the products released thereby, which are mostly gaseous, should be toxicologically harmless. A gas generator of this type provides safe and reliable operation within a wide temperature range thereby avoiding undesired triggering through mechanical or thermal influence. The small size of modern gas generators permits installation even in miniaturized modern communication means, such as mobile telephones, organizers, laptops or the like.

In accordance with the invention, the device is primarily disabled through generation of short-circuit connections such that, upon triggering, metal-containing liquid or solid aerosols are released through at least one combustible or at least one oxidant of the propellant and are deposited in the electronic device. The aerosols which are released by the propellant upon ignition, which may contain e.g. hot particles, drops of metal vapour, metal oxides or the like, deposit on the cold surface of the circuit boards or of the storage medium and damage the material structure in an irreparable manner to change the optical, dielectric and/or magnetic properties, e.g. by causing a short-circuit between the conductor tracks, wherein possible lacquer or protective layers are penetrated by the high thermal energy or via the penetration properties of aerosols generated: by the combustion process in e.g. hard disks or data carrier drives. The function of the device or the storage medium is permanently disabled by the metallic deposit i.e. in the latter case, the stored data is irretrievably deleted. The data may also be destroyed by irreversible thermal damage of the storage medium caused by combustion of the pyrotechnical propellant. Suitable location of the gas generator can thereby completely disable electronic components and devices.

In a preferred embodiment, the oxidant is selected from the group of metal nitrates, metal amine nitrates or mixtures thereof, wherein the oxidant may, in particular, be selected from the group of copper diamine dinitrate [Cu(NH₃)₂](NO₃)₂, copper tetramine dinitrate [Cu(NH₃)₄](NO₃)₂, basic copper nitrate Cu(NO₃)₂.3 Cu(OH)₂ or mixtures thereof. An oxidant of this type is known per se from DE 44 42 037 C1. It is non-toxic, produces non-toxic decomposition products and has a long service life and functionality at high burning speed even under extreme application conditions. It is also characterized by a small hygroscopicity which provides perfect performance even in moist surroundings. Burning of such an oxidant generates a strong metal-containing aerosol discharge which results in deposit of elementary copper onto the storage medium, permanently damaging same.

If only the applied oxidant effects the desired metal-containing aerosol discharge, any known organic or inorganic substances can be used as the combustible. The combustible may be selected e.g. from the group of 3-nitro-1,2,4-triazole-5-on (NTO), nitro guanidine (NIGU), triaminoguanidine nitrate (TAGN), 5-amino-1H-tetrazole (5-ATZ), diguanidinium-5,5′-azotetrazolate (GZT) or mixtures thereof. These combustibles are insensitive and toxicologically harmless and have a relatively high molecular nitrogen portion with a relatively low carbon portion which converts them mainly into non-toxic nitrogen (N₂). The oxidant substantially completely oxidizes the carbon portion into non-toxic carbon dioxide.

Should the combustible provide the desired metal-containing aerosol discharge instead of or in addition to the oxidant, the combustible is preferably selected from the group of fine-particle metals, semi-metals, alloys thereof or mixtures thereof which have a high oxygen reaction capacity (DE 44 42 027 C1). In this connection, metals of the group of aluminum (Al), silicon (Si), magnesium (Mg), titanium (Ti), tungsten (W), zirconium (Zr), copper (Cu), boron (B) or mixtures thereof in the form of fine particles are particularly suited and deposit on the storage medium in the form of metallic or solid metal oxide layer.

In another preferred embodiment, the combustible is selected from the group of metal-organic compounds, wherein e.g. metal alkyl-, metal alkenyl-, metal alkinyl-, metal aryl-, metal carbonyl compounds etc. can be used which contain, in particular, the above-mentioned metals, e.g. trimethyl aluminum (Al(CH₃)₃). Moreover, metal hydrogen compounds such as TiH₂, SiH₄ etc. have proven to be suitable.

The ignition of the gas generator may be initially triggered manually, wherein the ignition may be activated in response to repeated false input of a password. An attempt at unauthorized access to the data stored on the storage medium thereby causes destruction thereof. The ignition may be triggered by sensors, wherein basically any conventional sensors such as light barriers, motion detectors, heat or sound sensors, pressure sensors or the like may be used. An ignition which can be sensor-triggered is advantageous e.g. to protect storage media data in computers or microchips which are located in a stationary manner in buildings or transport means, e.g. civil or military airplanes with electronic weapon systems. Finally, the ignition may be triggered through remote control, in particular, through a code which can be transmitted via telephone or electronically, e.g. per e-mail or short-message-service (SMS) to provide effective protection from unauthorized access of stored data in case of theft of the devices, in particular, for portable devices such as laptops, mobile telephones or schedulers.

The above-mentioned ignition methods may be made more directed. In particular, the ignition can be activated electrically and is preferably supplied with current from a current supply means for the storage medium. If the storage medium is located in a stationary data processing system, the ignition is advantageously supplied by a mains voltage. If the storage medium is housed in portable devices, the ignition is suitably fed with current via batteries or storage batteries.

A simple and inexpensive structure of the inventive device is possible e.g. using an ignition wire which is connected to the propellant and initiates ignition of the propellant through electricity or heat.

The gas generator and the storage medium are preferably disposed in a protective housing to prevent discharge of the decomposition products of the propellant (in particular the metal-containing aerosol) into the surroundings when the propellant is burnt.

The invention also concerns an electronic data processing system, in particular, computers, laptops, schedulers or the like, a telephone, in particular, a mobile telephone or also a storage device such as a hard disk, an optical burner, or a reader comprising a storage medium such as a CD-ROM or DVD drive which have a device of the above-mentioned type.

The invention is explained in more detail below by means of one embodiment containing a storage medium, with reference to the drawing.

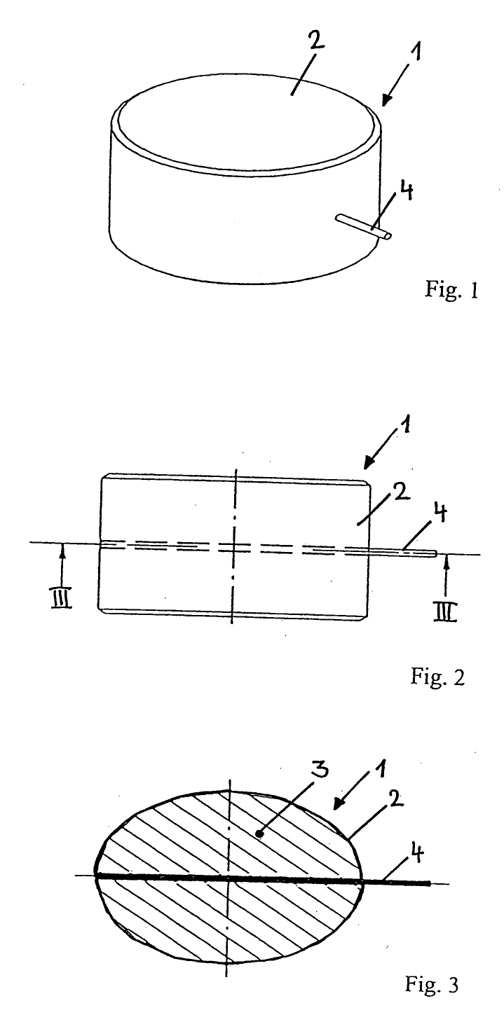

FIG. 1 shows a perspective view of a gas generator;

FIG. 2 shows a side view of the gas generator in accordance with FIG. 1;

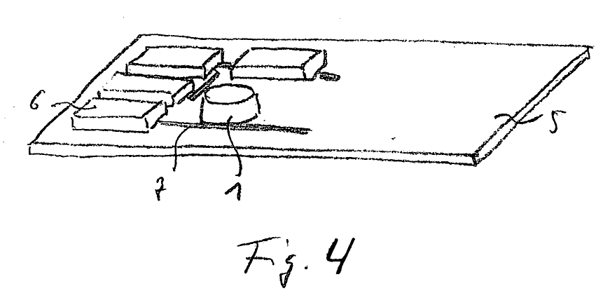

FIG. 3 shows a cross-section III-III through the gas generator of FIGS. 1, and 2; and

FIG. 4 shows the arrangement of an inventive device together with electronic components on a printed circuit board.

FIG. 1 shows a gas generator 1 which destroys data which is electronically stored on a storage medium (not shown) and is disposed in the direct vicinity of the storage medium, e.g. on a board (FIG. 4) of a microchip. The gas generator 1 has a housing 2 and a propellant 3 stored in the housing 2 (FIG. 3). In the present embodiment, the housing is formed by a thin-walled plastic cylinder which breaks when the propellant 3 is ignited. The propellant 3 consists e.g. of a homogeneous mixture of fine-particle aluminum powder (combustible) and [Cu(NH₃)₄](NO₃)₂ and Cu(NO₃)₂.3 Cu(OH)₂ (oxidant) in a ratio of approximately 5:70:25 mass %. An ignition which is not shown in detail has an ignition wire 4 incorporated in the propellant 3 which, in the present embodiment, radially penetrates the cylindrical housing 2. The ignition is supplied with current from a current supply means of the storage medium and can be triggered e.g. via a remotely transmitted code. The gas generator 1 and the storage medium can be housed in a common protective housing (not shown). The gas generator 1 is shown again in side view in FIG. 2.

FIG. 4 shows a printed circuit board 5 which comprises electronic components 6 and, as an example, some conductive tracks 7, and finally one inventive device in the form of a gas generator 1.

Ignition of the gas generator 1 generates a pressure wave which breaks the housing 2, and burning of the propellant 3 produces metal-containing aerosols which deposit on the storage medium in the form of a metal or metal oxide layer which cannot be removed. The storage medium is moreover thermally damaged by the released reaction enthalpy. The storage medium is thereby irreparably damaged with the consequence that the data stored thereon is destroyed in a permanent and irretrievable manner.

1-25. (canceled)

26. A device for disabling electronic devices, the device comprising:
a gas generator having a pyrotechnical propellant, wherein, when triggered, at least one combustible or at least one oxidant of the propellant releases metals which have good conducting properties and which deposit on electronic parts of the electronic device.

27. The device of claim 26, wherein said metals comprise precious or semi-precious metals.

28. The device of claim 26, wherein said combustible and/or said oxidant release said metals in vapour or aerosol form.

29. The device of claim 28, wherein said aerosol is a liquid or a solid.

30. The device of claim 26, wherein said propellant is structured and dimensioned for disposition proximate at least one of a circuit board and/or a storage medium of the electronic device.

31. The device of claim 26, wherein said oxidant comprises mixtures selected from the group consisting of metals, precious or semi-precious metal nitrates, and metal amine nitrates.

32. The device of claim 31, wherein said oxidant comprises copper compounds of precious metals, semi-precious metals or mixtures thereof selected from the group consisting of copper diamine dinitrate [Cu(NH₃)₂](NO₃)₂, copper tetramine dinitrate [Cu(NH₃)₄](NO₃)₂, and basic copper nitrate Cu(NO₃)₂.3 Cu(OH)₂.

33. The device of claim 26, wherein said combustible comprises a precious metal or a semi-precious metal having a high oxygen reaction capacity, alloys thereof or mixtures of alloys thereof, discharged in the form of fine particles.

34. The device of claim 33, wherein said combustible, in fine particle form, is selected from the group consisting of aluminum (Al), silicon (Si), magnesium (Mg), titanium (Ti), tungsten (W), zirconium (Zr), copper (Cu), boron (B) or mixtures thereof.

35. The device of claim 26, wherein said combustible comprises a metallic organic compound.

36. The device of claim 26, wherein said combustible comprises a metallic hydrogen compound.

37. The device of claim 26, wherein said gas generator comprises an ignition which communicates with the propellant.

38. The device of claim 37, wherein said ignition is structured and dimensioned for manual triggering.

39. The device of claim 37, wherein said ignition is structured and dimensioned for triggering by a sensor.

40. The device of claim 38, wherein said ignition is structured and dimensioned for triggering by a remote control.

41. A storage device comprising the device of claim 26.

42. A reader having a storage medium, wherein the reader comprises the device of claim 26.

43. A method for disabling electronic devices, the method comprising the steps of:
a) disposing a gas generator in the electronic device; and
b) igniting said gas generator with a pyrotechnical propellant which contains at least one combustible or at least one oxidant, wherein, upon triggering said propellant, said gas generator releases metals having good conducting properties which deposit on the electronic parts of the electronic device.

44. The method of claim 43, wherein said metals comprises precious metals or semi-precious metals.

45. The method of claim 43, wherein said combustible or oxidant releases said metals in vapor or aerosol form.

46. The method of claim 43, wherein said propellant is structured and dimensioned for disposition proximate a circuit board and/or a storage medium of the electronic device.

47. The method of claim 43, wherein said oxidant comprises a precious or semi-precious metal nitrate, or mixtures thereof.

48. The device of claim 47, wherein said oxidant comprises a copper compound of a precious or semi-precious metal selected from the group consisting of copper diamine dinitrate [Cu(NH₃)₂](NO₃)₂, copper tetramine dinitrate [Cu(NH₃)₄](NO₃)₂, and basic copper nitrate Cu(NO₃)₂.3 Cu(OH)₂, or mixtures thereof.

49. The method of claim 43, wherein said combustible comprises a precious or semi-precious metal having high oxygen reaction capacity.

50. The method of claim 49, wherein said combustible comprises a precious or semi-precious metal alloy or mixtures thereof discharged in the form of fine particles.

51. The method of claim 49, wherein said combustible comprises at least one of aluminum (Al), silicon (Si), magnesium (Mg), titanium (Ti), tungsten (W), zirconium (Zr), copper (Cu), boron (B), in fine particle form.

52. The method of claim 43, wherein said combustible comprises a metal organic compound.

53. The method of claim 43, wherein said combustible comprises a metallic hydrogen compound.

54. The method of claim 43, wherein said propellant is ignited by a gas generator ignition device which functionally communicates therewith.
